(19) United States
(12) Patent Application Publication
(10) Pub. No.: US 2019/0293981 A1
(43) Pub. Date: Sep. 26, 2019

(54) CHOLESTERIC LIQUID CRYSTAL WRITING BOARD

(71) Applicant: IRIS OPTRONICS CO., LTD., Tainan City (TW)

(72) Inventors: Chi-Chang LIAO, Tainan City (TW); Shu-Shien LIU, Tainan City (TW); Tsung-Ming PAI, Tainan City (TW); Fu-Ming WANG, Tainan City (TW)

(21) Appl. No.: 15/974,219

(22) Filed: May 8, 2018

(30) Foreign Application Priority Data
Mar. 21, 2018 (TW) 107109739

(51) Int. Cl. G02F 1/1333; G02F 1/133; G02F 1/1343

(52) U.S. Cl. CPC G02F 1/13338; G02F 1/13318; G02F 1/133305; G02F 1/134336; G02F 1/133345; G02F 1/13439

(57) ABSTRACT

A cholesteric liquid crystal writing board can display a writing track, and comprises a cholesteric liquid crystal device, a photo-sensing array layer, a sensing-signal processing circuitry and a voltage control circuitry. The cholesteric liquid crystal device comprises a plurality of liquid crystal control areas. The photo-sensing array layer comprises a plurality of photo-sensing dot-areas arranged in an array, a photo-sensing element of the photo-sensing dot-area senses a luminous flux change and generates a sensing signal. The sensing-signal processing circuitry receives the sensing signal and accordingly outputs position data of the photo-sensing element in the photo-sensing array layer. The voltage control circuitry receives the position data and accordingly outputs a voltage signal to the liquid crystal control area corresponding to the position data, so that cholesteric liquid crystals corresponding to partial or all portions of the liquid crystal control areas are morphologically changed to erase partial or all portions of the writing track accordingly.

### CROSS REFERENCE TO RELATED APPLICATIONS

This Non-provisional application claims priority under 35 U.S.C. § 119(a) on Patent Application No(s). 107108729 filed in Taiwan, Republic of China on Mar. 14, 2018, and the entire contents of which are hereby incorporated by reference.

### BACKGROUND OF THE INVENTION

### Field of Invention

The invention relates to a cholesteric liquid crystal writing board, and more particularly to a cholesteric liquid crystal writing board with an erasing function.

### Related Art

In cholesteric liquid crystals, chiral dopants are added to nematic liquid crystals to make the liquid crystal molecules to have a helical arrangement structure, and two different arrangement states of liquid crystal molecules rendering reflection and penetration under various voltage differences are utilized to achieve different light transmission rates to achieve the display effect. The principle is that, when a low voltage or a high voltage is externally applied, the liquid crystal molecules may be transformed into a focal conic state and a homeotropic state from the planar state, respectively. When the cholesteric liquid crystal molecules are in the planar state, part of the incident light is reflected to show a color. When the cholesteric liquid crystal molecules are in the focal conic state, most of the incident light pass through those molecules and a small portion thereof is scattered. When the cholesteric liquid crystal molecules are in the vertical state, the incident light may pass through those molecules completely.

The planar state and the focal conic state are both stable states. When the applied voltage is turned off, the state of the molecules and the displayed images stay. The voltage is only applied when the state of the cholesteric crystal liquid molecules need to be changed to another state and when the displayed images need to be refreshed. Its properties, such as power-saving and the memorability, also make the cholesteric liquid crystals become the first choice for e-books. In addition, this display mechanism is less affected by the gap between the upper and lower plates, and potentially can be applied in a bistable flexible display. Compared with other types (e.g. TN-type) of liquid crystal displays, the cholesteric liquid crystal display has the advantages of power-saving, colorful display, light-adjusting, and the ability to be applied in a bistable flexible display, which contribute to its wide application

### SUMMARY OF THE INVENTION

In view of the foregoing objectives, a cholesteric liquid crystal writing board with the wipe function is provided. The cholesteric liquid crystal writing board of the present disclosure utilizes the properties of the cholesteric liquid crystal. In addition to achieving power-saving, it is also possible to perform a function of erasing the designated portion(s) of an image displayed on the cholesteric liquid crystal writing board, so as to expand the application of the cholesteric liquid crystal writing board on the teaching or conference.

To achieve the above objective, a cholesteric liquid crystal writing board is provided. The cholesteric liquid crystal writing board is capable of displaying a writing track and comprises a cholesteric liquid crystal device, a photo-sensing array layer, a sensing-signal processing circuitry and a voltage control circuitry. The cholesteric liquid crystal device comprises a cholesteric liquid crystal layer. The cholesteric liquid crystal device has a light-entering surface and a light-emitting surface opposite to the light-entering surface, and comprises a plurality of liquid crystal control areas. The photo-sensing array layer is disposed on one side of the light-emitting surface of the cholesteric liquid crystal device. The photo-sensing array layer comprises a plurality of photo-sensing dot-areas arranged in an array, and a photo-sensing element of one of the photo-sensing dot-areas senses a luminous flux change and generates a sensing signal accordingly. Said one of the photo-sensing dot-areas corresponds to at least one of the liquid crystal control areas. The sensing-signal processing circuitry is coupled to the photo-sensing array layer. The sensing-signal processing circuitry receives the sensing signal and accordingly outputs position data of the photo-sensing element in the photo-sensing array layer. The voltage control circuitry is coupled to the sensing-signal processing circuitry and the cholesteric liquid crystal device. The voltage control circuitry receives the position data and accordingly outputs a voltage signal to the liquid crystal control area corresponding to the position data, so that cholesteric liquid crystals corresponding to partial or all portions of the liquid crystal control areas are morphologically changed so as to erase partial or all portions of the writing track accordingly.

In one embodiment, the cholesteric liquid crystal device further comprises a first substrate and a second substrate opposite to the first substrate. The cholesteric liquid crystal layer is disposed between the first substrate and the second substrate. The cholesteric liquid crystal device further comprises a first transparent electroconductive layer disposed on a surface of the first substrate facing toward the cholesteric liquid crystal layer, and the cholesteric liquid crystal device further comprises a second transparent electroconductive layer disposed on one side of the second substrate facing toward the cholesteric liquid crystal layer.

In one embodiment, the first transparent electroconductive layer comprises a plurality of first electrodes which extend in a first direction and are separately disposed. The second transparent electroconductive layer comprises a plurality of second electrodes which extend in a second direction and are separately disposed, and the first direction is different from the second direction.

In one embodiment, when viewing from a top of the light-entering surface, the first electrodes are crossed with the second electrodes to correspond to the liquid crystal control areas.

In one embodiment, the voltage signal is applied to the first electrode and the second electrode of one or more of the liquid crystal control areas corresponding to the position data, so that the cholesteric liquid crystals corresponding to partial or all of said one or more of the liquid crystal control areas are morphologically changed.

In one embodiment, the second transparent electroconductive layer comprises a plurality of electrode blocks arranged in an array. The electrode blocks are disposed in correspondence with the photo-sensing dot-areas, and the electrode blocks and the first transparent electroconductive layer correspondingly form the liquid crystal control areas.

In one embodiment, the voltage signal is applied to the electrode blocks of one or more of the liquid crystal control areas corresponding to the writing track, so that the cholesteric liquid crystals corresponding to partial or all of said one or more of the liquid crystal control areas are morphologically changed.

In one embodiment, the first transparent electroconductive layer or the second transparent electroconductive layer comprises a plurality of electrode blocks, and the electrode blocks are disposed in correspondence with the liquid crystal control areas.

In one embodiment, the voltage signal is applied to the electrode blocks of one or more of the liquid crystal control areas corresponding to the position data, so that the cholesteric liquid crystals corresponding to partial or all of said one or more of the liquid crystal control areas are morphologically changed.

In one embodiment, the cholesteric liquid crystal device further comprises an insulating layer. The second transparent electroconductive layer, the insulating layer, and the photo-sensing array layer are sequentially stacked on a surface of the second substrate facing toward the cholesteric liquid crystal layer.

In one embodiment, the photo-sensing array layer is disposed on a surface of the second substrate opposite to the cholesteric liquid crystal layer in a back-to-back manner.

In one embodiment, the photo-sensing array layer is disposed on one side of the second substrate opposite to the cholesteric liquid crystal layer. The photo-sensing array layer further comprises a third substrate, and the photo-sensing dot-areas arranged in the array are disposed on a surface of the third substrate facing toward the second substrate.

In one embodiment, the photo-sensing array layer further comprises a plurality of upload-lines and a plurality of read-lines which are disposed crossed to the upload-lines to define the photo-sensing dot-areas. A switch element and one of the photo-sensing elements are disposed in each of the photo-sensing dot-areas. A control terminal of the switch element is connected to one of the upload-lines. A first terminal of the switch element is connected to one of the read-lines. A second terminal of the switch element is connected to one terminal of said photo-sensing element. The other terminal of said photo-sensing element is connected to a reference voltage.

In one embodiment, the sensing signal is transmitted to the sensing-signal processing circuitry when the upload-lines are turned on.

In one embodiment, the sensing signal is transmitted to the sensing-signal processing circuitry in a blanking time after the upload-lines are turned on.

In one embodiment, a light irradiates the light-entering surface of the cholesteric liquid crystal device to generate the luminous flux change, and the position data comprises position information regarding to where the cholesteric liquid crystal device is irradiated by the light.

In one embodiment, the light is a visible light or an invisible light.

As mentioned above, in the cholesteric liquid crystal writing board according to the present disclosure, the cholesteric liquid crystal device comprises a plurality of liquid crystal control areas. The photo-sensing layer which comprises a plurality of photo-sensing dot-areas arranged in an array is disposed on one side of the light-emitting surface of the cholesteric liquid crystal device. A photo-sensing element of one of the photo-sensing dot-areas may sense a luminous flux change and generate a sensing signal accordingly. Said one of the photo-sensing dot-areas corresponds to at least one of the liquid crystal control areas. The sensing-signal processing circuitry receives the sensing signal and accordingly outputs position data of the photo-sensing element in the photo-sensing array layer. The voltage control circuitry receives the position data and accordingly outputs a voltage signal to the liquid crystal control area corresponding to the position data, so that cholesteric liquid crystals corresponding to partial or all portions of the liquid crystal control areas are morphologically changed so as to erase partial or all portions of the writing track accordingly. Hence, the cholesteric liquid crystal writing board of the present disclosure utilizes the properties of the cholesteric liquid crystal. In addition to achieving power-saving, it is also possible to perform a function of erasing the designated portion(s) of an image displayed on the cholesteric liquid crystal writing board, so as to expand the application of the cholesteric liquid crystal writing board on the teaching or conference.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1A is a schematic application view showing an embodiment of the cholesteric liquid crystal writing board of this disclosure.

FIG. 1B is a partially enlarged schematic view showing a writing track of FIG. 1A.

FIG. 1C shows that the writing track of FIG. 1B is partially erased.

FIG. 2A is a partially-exploding stereoscopic schematic view showing an embodiment of the cholesteric liquid crystal writing board of this disclosure.

FIG. 2B is a partially stereoscopic view showing an embodiment of the cholesteric liquid crystal writing board of this disclosure.

FIG. 2C is a schematic top view showing a first transparent electroconductive layer and a second transparent electroconductive layer of the cholesteric liquid crystal writing board of FIG. 2B.

FIG. 2D is a schematic view showing the cholesteric liquid crystal writing board of FIG. 1.

FIG. 2E is a schematic circuit diagram showing a photo-sensing area of a photo-sensing array layer of the cholesteric liquid crystal writing board of FIG. 2D.

FIG. 3A is a schematic view showing an embodiment regarding to the correspondence between the liquid crystal control areas and the photo-sensing areas of the cholesteric liquid crystal writing board of this disclosure.

FIG. 3B is a schematic view showing another embodiment regarding to the correspondence between the liquid crystal control areas and the photo-sensing dot-areas of the cholesteric liquid crystal writing board of this disclosure.

FIG. 3C is a schematic view showing still another embodiment regarding to the correspondence between the liquid crystal control areas and the photo-sensing dot-areas of the cholesteric liquid crystal writing board of this disclosure.

FIG. 3D is a schematic view showing another embodiment of a second transparent electroconductive layer of the cholesteric liquid crystal writing board of this disclosure.

FIG. 3E is a schematic view showing another embodiment of the first transparent electroconductive layer and the second transparent electroconductive layer of the cholesteric liquid crystal writing board of this disclosure.

FIG. 4A to FIG. 4D are schematic structure views showing various embodiments of the cholesteric liquid crystal writing board of this disclosure, respectively.

### DETAILED DESCRIPTION OF THE INVENTION

The embodiments of the invention will be apparent from the following detailed description, which proceeds with reference to the accompanying drawings, wherein the same references relate to the same elements.

It is to be noted that all directional indications (such as up, down, left, right, front, rear and the like) in the embodiments of the present disclosure are only used for explaining the relative positional relationship, circumstances during its operation, and the like, between the various components in a certain specific posture (as shown in the accompanying drawings). If the specific posture changes, the directional indication will also change accordingly.

The cholesteric liquid crystal writing board provided in the embodiments of the present disclosure can be written or drawn to show texts and/or images on the writing surface thereof, and can be applied to, for example but without limiting to, mobile phones, tablets, electronic whiteboards, or any other display devices that can display images. In this invention, an erasing function may be performed to erase partial or all portions of a writing track shown on the cholesteric liquid crystal writing board.

The cholesteric liquid crystal writing boards in the following embodiments are exemplified by large-sized electronic blackboards (or whiteboards) applied to an interactive writing system, such as those used in a conference or a classroom, but the present disclosure is not limited thereto. The cholesteric liquid crystal writing boards provided in the embodiments of the present disclosure utilize the properties of cholesteric liquid crystal molecules and are therefore bistable display apparatuses. When the cholesteric liquid crystal writing board displays an image or a frame, no additional power is required, and this image or frame stays as is. Additional power is only required when the cholesteric crystal molecules needs to be changed to another state or the displayed frame(s) needs to be refreshed. Hence, the cholesteric liquid crystal writing board is a relatively power-saving electronic device.

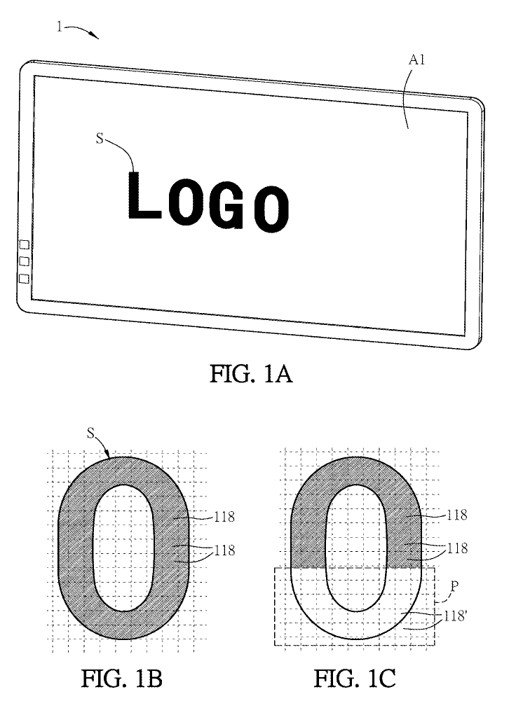

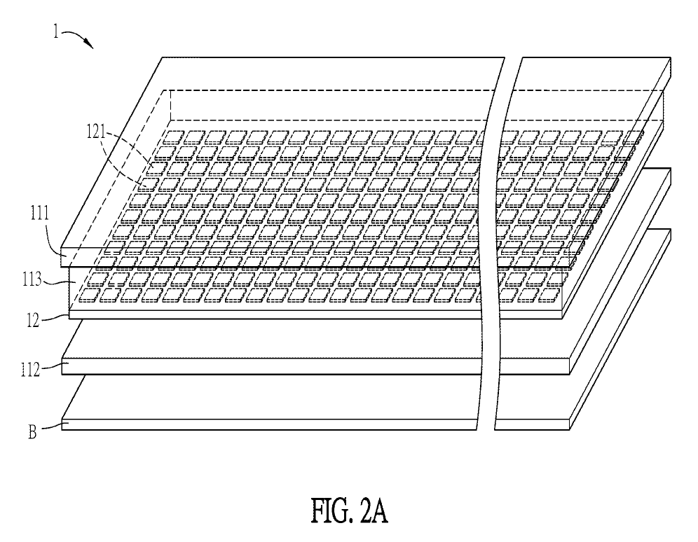

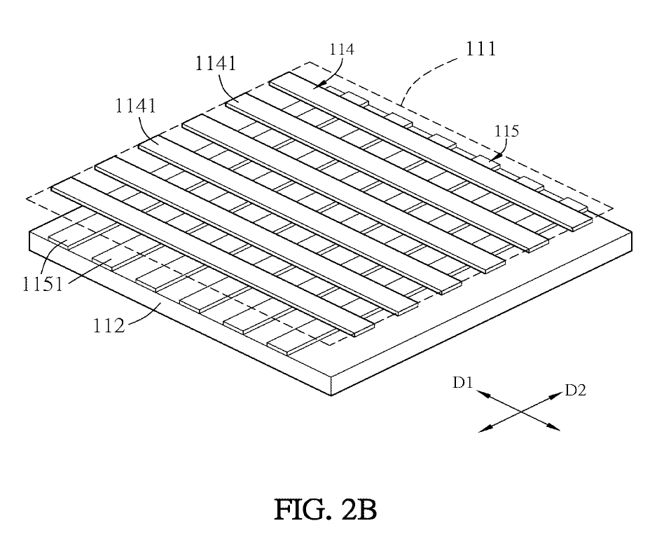

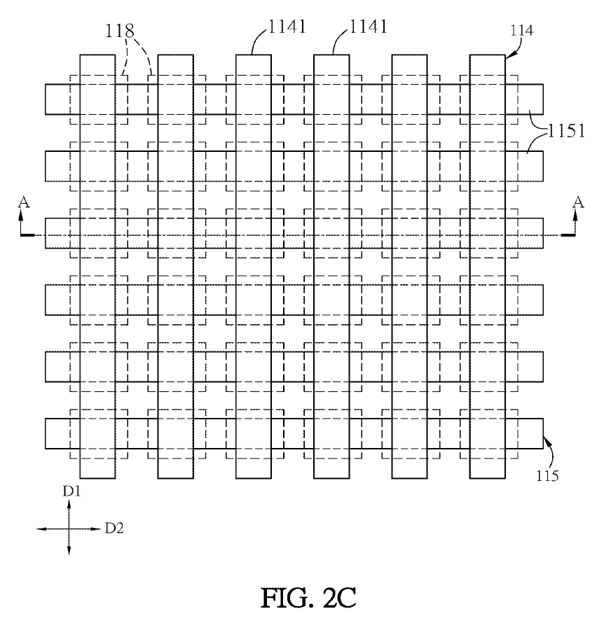

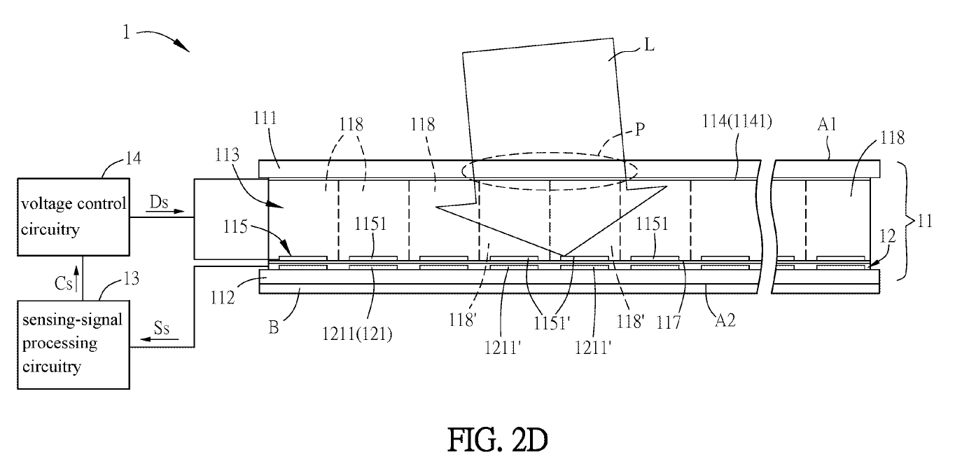

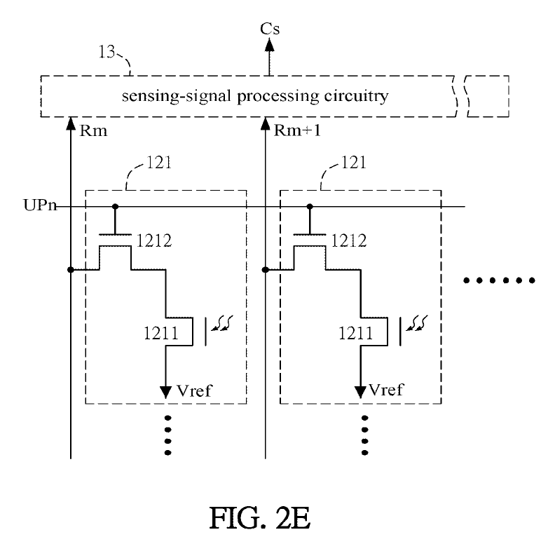

FIG. 1A is a schematic application view showing an embodiment of the cholesteric liquid crystal writing board of this disclosure. FIG. 1B is a partially enlarged schematic view showing a writing track of FIG. 1A. FIG. 1C shows that the writing track of FIG. 1B is partially erased. FIG. 2A is a partially-exploding stereoscopic schematic view showing an embodiment of the cholesteric liquid crystal writing board of this disclosure. FIG. 2B is a partially stereoscopic view showing an embodiment of the cholesteric liquid crystal writing board of this disclosure. FIG. 2C is a schematic top view showing a first transparent electroconductive layer and a second transparent electroconductive layer of the cholesteric liquid crystal writing board of FIG. 2B. FIG. 2D is a schematic view showing the cholesteric liquid crystal writing board of FIG. 1. FIG. 2E is a schematic circuit diagram showing a photo-sensing area of a photo-sensing array layer of the cholesteric liquid crystal writing board of FIG. 2D.

As shown in FIG. 1 and through FIG. 2A to FIG. 2D, a cholesteric liquid crystal writing board 1 may comprise a cholesteric liquid crystal device 11, a photo-sensing array layer 12, a sensing-signal processing circuitry 13 and a voltage control circuitry 14. The cholesteric liquid crystal writing board 1 can display a writing track S. The cholesteric liquid crystal device 11 has a light-entering surface A1 and a light-emitting surface A2 opposite to the light-entering surface A1, and the cholesteric liquid crystal device 11 comprise a plurality of liquid crystal control areas 118 (as shown in FIG. 2C and FIG. 2D). The light-entering surface A1 of this embodiment is a surface of the cholesteric liquid crystal writing board 1 facing toward the user, and is also referred to a writing surface or a display surface. The user can write thereon to generate a writing track S. In some embodiments, a protective film layer or protective substrate may be further provided on the light-entering surface A1 to protect the cholesteric liquid crystal writing board 1.

The cholesteric liquid crystal device 11 may display a color correspondingly. In details, the cholesteric liquid crystal device 11 may be prepared to show colors, such as red (R), green (G), or blue (B) and the like, by adding various chiral dopants with different contents. Herein, the color correspondingly displayed by the cholesteric liquid crystal device 11 may be selected from, for example but without limiting to, either red, green, blue, or other color of visible light. The specific orientation of the cholesteric liquid crystal molecules is achieved by adding chiral dopants to the nematic liquid crystal molecules. The display and erasing function is achieved by using cholesteric liquid crystal molecules which may exhibit various stable states and transient states, such as at least a focal conic state, a planar state and a homeotropic state, and the like, under various voltages, physical pressures and/or temperatures. Hence, by changing the axial orientation of the helical structure of the cholesteric liquid crystal molecules, a portion of the incident light is reflected and/or a portion of the light may pass through the cholesteric liquid crystals. In other words, the display, writing, and/or erasing functions of the cholesteric liquid crystal device 11 may be achieved with the different optical reflectance or transmittance possessed by the cholesteric liquid crystal molecules at different stable states or transient states.

The photo-sensing array layer 12 is disposed on one side of the light-emitting surface A2 of the cholesteric liquid crystal device 11. The photo-sensing array layer 12 may comprise a plurality of photo-sensing dot-areas 121 or photo-sensing elements 1211 arranged in an array, and a photo-sensing area 121 or photo-sensing element 1211 may correspond to at least one or a plurality of liquid crystal control areas 118. As shown in FIG. 2D, in this embodiment, as an example, a photo-sensing area 121 corresponds to a liquid crystal control area 118. One or more of the photo-sensing elements 1211 disposed in the photo-sensing dot-area(s) 121 can sense a luminous flux change and generate a sensing signal Ss accordingly. The sensing-signal processing circuitry 13 is coupled to the photo-sensing array layer 12, and receives the sensing signal Ss and accordingly outputs position data Cs of the photo-sensing element 121 in the photo-sensing array layer 12 when the foregoing situation occurs. The voltage control circuitry 14 is coupled to the sensing-signal processing circuitry 13 and the cholesteric liquid crystal device 11. The voltage control circuitry 14 can receive the position data Cs generated by the sensing-signal processing circuitry 13 due to the luminous flux change, and accordingly output a voltage signal Ds to the liquid crystal control area 118 corresponding to the writing track S, so that cholesteric liquid crystals corresponding to partial or all portions of the liquid crystal control areas 118 are morphologically changed to erase, partially or entirely, the writing track S accordingly. In details, when the light L irradiates the cholesteric liquid crystal device 11 and the photo-sensing array layer 12 senses the sensing signal Ss generated by the luminous flux change caused by the light L, the position of the photo-sensing element 121 (which receives the L) in the photo-sensing array layer 12 can be obtained, and thus the position of the irradiation region P caused by the light Lon the cholesteric liquid crystal device 11 can be obtained. Later, by using the voltage control circuitry 14 to control the cholesteric liquid crystal molecules in partial or all the liquid crystal control areas 118 corresponding to the irradiation region P to undergo a morphological change, the writing track S in irradiation region P can be erased, partially or entirely.

Hereinafter, the structure of the cholesteric liquid crystal device 11 will be described. In this embodiment, FIG. 2D depicts a cross-sectional view of the first transparent electroconductive layer 114 and the second transparent electroconductive layer 115 of the cholesteric liquid crystal device 11 along the A-A line shown in FIG. 2C. As shown in through FIG. 2B to FIG. 2D, the cholesteric liquid crystal device 11 may comprise a first substrate 111, a second substrate 112 and a cholesteric liquid crystal layer 113. The first substrate 111 is disposed opposite to the second substrate 112, the cholesteric liquid crystal layer 113 has a plurality of cholesteric liquid crystal molecules (not shown in the drawings), and the cholesteric liquid crystal molecules may be filled between the first substrate 111 and the second substrate 112. The cholesteric liquid crystal device 11 further comprises a first transparent electroconductive layer 114 disposed on a surface of the first substrate 111 facing toward the cholesteric liquid crystal layer 113. The cholesteric liquid crystal device 11 further comprises a second transparent electroconductive layer 115 disposed on one side of the second substrate 112 facing toward the cholesteric liquid crystal layer 113.

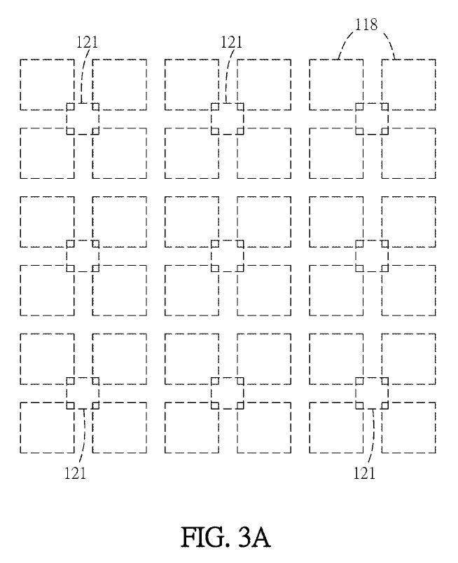

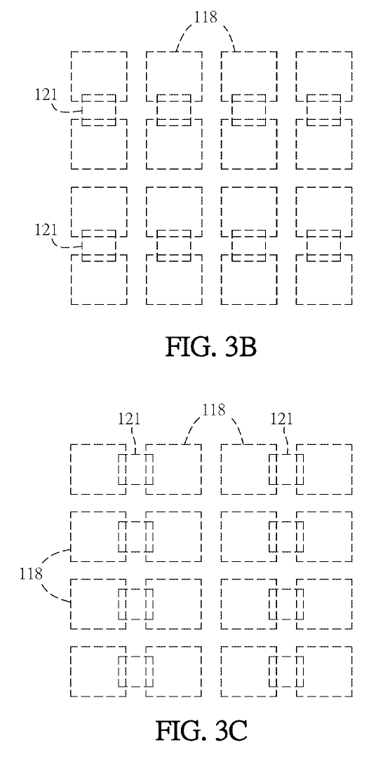

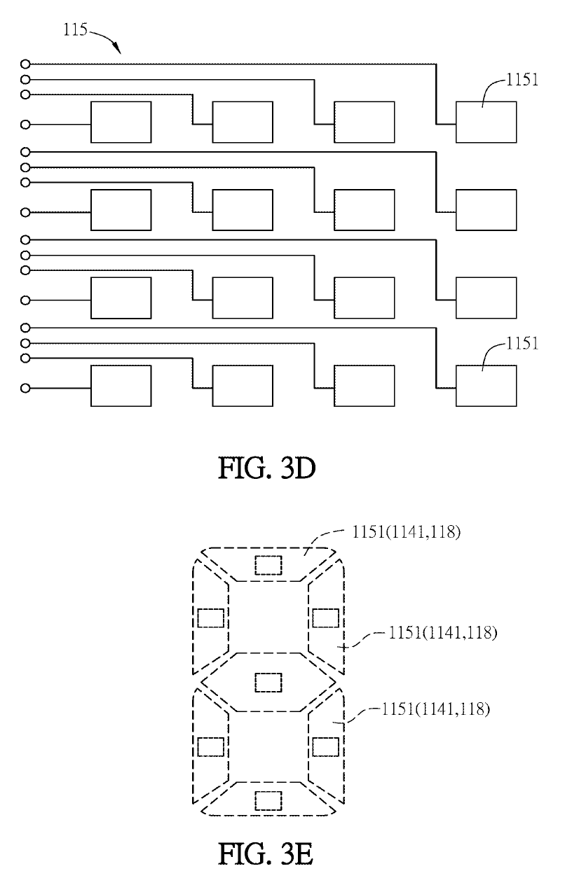

As shown in FIG. 2B and FIG. 2C, the first transparent electroconductive layer 114 of this embodiment comprises a plurality of first electrodes 1141 which extend in a first direction D1 and are separately disposed, the second transparent electroconductive layer 115 comprises a plurality of second electrodes 1151 which extend in a second direction D2 and are separately disposed. The first direction D1 is different from the second direction D2. Herein, the first direction D1 and the second direction D2 may form an angle, which comprises, for example but without limiting to, 90 degrees. Hence, from a top view of the light-entering surface A1, the first electrodes 1141 are crossed with the second electrodes 1151 and their intersections are disposed in correspondence to the liquid crystal control areas 118. Herein, the cholesteric liquid crystal molecules corresponding to the intersection of the first electrode 1141 and the second electrode 1151 can form a liquid crystal control area 118 (see also FIG. 2D), and a liquid crystal control area 118 may be disposed correspondingly to a photo-sensing area 121 (for the sake of clarity of the drawing, the photo-sensing dot-area 121 is not shown in FIG. 2C). Alternatively, in other embodiments, as shown in FIG. 3A, multiple (e.g., four) liquid crystal control areas 118 may be also disposed in correspondence to the same one photo-sensing area 121. Further alternatively, as shown in FIG. 3B, every two liquid crystal control areas 118 in a column is disposed in correspondence to a photo-sensing area 121. Still alternatively, as shown in FIG. 3C, every two liquid crystal control areas 118 in a row is disposed in correspondence to a photo-sensing area 121. However, the amount of the liquid crystal control areas 118 that are disposed in correspondence to a photo-sensing area 121 and the arrangement of the two components may be adjusted according to practical requirement(s), and this disclosure is not limited thereto.

Referring again to FIG. 2C and FIG. 2D, the voltage control circuitry 14 controls a voltage difference between the first electrode 1141 and the second electrode 1151 to control the orientation state of the cholesteric liquid crystal molecules at the intersection region of the first electrode 1141 and the second electrode 1151, thereby controlling the morphological change of the cholesteric liquid crystal molecules. In addition, the cholesteric liquid crystal device 11 may further comprise a sealing layer (not shown). The sealing layer is disposed between the first substrate 111 and the second substrate 112, and seals the outer peripheries of the first substrate 111 and the second substrate 112, so that a gap is formed between the first substrate 111 and the second substrate 112. A chamber may be formed by the first substrate 111, the second substrate 112 and the sealing layer, so that the cholesteric liquid crystal molecules may be filled into the chamber to form the cholesteric liquid crystal layer 113. It is noted that in this embodiment, the light-entering surface A1 of the cholesteric liquid crystal device 11 refers to the upper surface of the first substrate 111 which is disposed opposite to (or away from) the cholesteric liquid crystal layer 113, and the light-emitting surface A2 refers to the lower surface of the second substrate 112 which is disposed opposite to (or away from) the cholesteric liquid crystal layer 113. Alternatively, the light-entering surface A1 may refer to the upper surface of the cholesteric liquid crystal layer 113 facing toward the first substrate 111, and the light-emitting surface A2 may refer to the lower surface of the cholesteric liquid crystal layer 113 facing toward the second substrate 112, or any combination of the preceding examples, and the present invention is not limited thereto.

In this embodiment, the first substrate 111 and the second substrate 112 may individually comprise a transparent substrate, and may be a flexible transparent substrate or a rigid transparent substrate. The material of the flexible transparent substrate comprises, for example but without limiting to, polyimide (PI), polycarbonate (PC) or polyethylene terephthalate (PET). The material of the rigid transparent substrate comprises, for example but without limiting to, glass, quartz or sapphire. If the first substrate 111 and the second substrate 112 are both made of the flexible transparent material(s), then the cholesteric liquid crystal writing board 1 may be made into a curved display because such transparent substrate is flexible. In addition, the first transparent electroconductive layer 114 and the second transparent electroconductive layer 115 may be, for example but without limiting to, indium tin oxide (ITO) or indium zinc oxide (IZO), and the present invention is not limited thereto.

Hereinafter, the structure of the photo-sensing array layer 12 of the cholesteric liquid crystal writing board 1 of this embodiment will be described.

Referring to FIG. 2E, in the present embodiment, the photo-sensing array layer 12 further comprises a plurality of upload-lines UPn and a plurality of read-lines Rm and Rm+1. The upload-lines UPn are crossed with the read-lines Rm and Rm+1 so as to define a plurality of photo-sensing dot-areas 121. The sensing-signal processing circuitry 13 is coupled to the photo-sensing array layer 12. Herein, FIG. 2E is a schematic circuit diagram showing two adjacent photo-sensing dot-areas 121.

In FIG. 2E, each of the photo-sensing dot-areas 121 may comprise a photo-sensing element 1211 and a switch element 1212. A control terminal of the switch element 1212 is connected to one of the upload-lines UPn. A first terminal of the switch element 1212 is connected to one of the read-lines Rm and Rm+1. A second terminal of the switch element 1212 is connected to one terminal of the photo-sensing element 1211, and another terminal of the photo-sensing element 1211 is coupled to a reference voltage Vref. The reference voltage Vref may be, for example but without limiting to, a common voltage (Vcom), a gate voltage (Vgate) or a grounding voltage (Vgnd) or the like, according to practical requirements. The switch element 1212 and the photo-sensing element 1211 are coupled to the sensing-signal processing circuitry 13 through the read-lines Rm and Rm+1. Herein, the switch element 1212 may be, for example, a thin film transistor, and the photo-sensing element 1211 may be made using the same process and material as the switch element 1212 to save costs. Moreover, the sensing-signal processing circuitry 13 may be implemented by way of, for example but without limiting to, an integrated circuit or a microchip or other ways. The position-detection is carried out by obtaining difference(s) of the various photoelectric currents caused by the luminous flux change generated upon the photo-sensing element 1211 being irradiated by the light or not, or irradiated with various irradiation amounts/intensities.

In details, when the switch element 1212 on the left side of FIG. 2E is taken as an example, a gate of the switch element 1212 (thin film transistor) is connected/coupled to the upload-line UPn, a first terminal (source) thereof is connected/coupled to the read-line Rm, a second terminal (drain) thereof is connected/coupled to one terminal of the photo-sensing element 1211, and another terminal of the photo-sensing element 1211 may be connected/coupled to a common voltage (Vcom), such as the ground. Hence, when a signal transmitted via the upload-line UPn turns on the switch element 1212, the sensing-signal processing circuitry 13 coupled thereto can receive the sensing signal Ss generated by the photo-sensing element 1211 due to the luminous flux change through the read-line Rm and the switch element 1212, and outputs the position data Cs according to the received sensing signal Ss. The position data Cs comprises the position (or coordinate) information about where the said photo-sensing element 1211 (i.e. the photo-sensing element 1211 which generates such photoelectrical current/sensing signal) locates in the photo-sensing array layer 12.

Hereinafter, it is to describe how the cholesteric liquid crystal writing board 1 obtains the occurrence position of a morphological change of the cholesteric crystal molecules (or the luminous flux change of the photo-sensing element 1211) and thus obtains the irradiation position of the light L on the cholesteric liquid crystal device 11 when the luminous flux changes are occurred in the cholesteric liquid crystal device 11 which are caused by the light L.

Please refer again to through FIG. 1A to FIG. 1C and through FIG. 2A to FIG. 2E. In the cholesteric liquid crystal writing board 1 of this embodiment, when the user writes a letter, a character, or a word, or draws a figure on the cholesteric liquid crystal writing board 1 to cause the orientation of the cholesteric liquid crystal molecules in the corresponding liquid crystal control area(s) 118 to become a planar state due to the pressure in the cholesteric liquid crystal device 11 so as to generate the writing track S (e.g., a “LOGO” pattern shown in FIG. 1A), the writing track S will render a color (e.g., green) corresponding to the cholesteric liquid crystal device 11. In other words, at this time, the cholesteric liquid crystal molecules in the liquid crystal control area 118 corresponding to the writing track S are in a planar state. In addition, as shown in FIG. 1A, FIG. 1B and FIG. 2D, the photo-sensing element 1211 in the photo-sensing dot-area 121 corresponding to the writing track S may sense the luminous flux of the environment light transmitted to the photo-sensing array layer 12 sequentially through the first substrate 111 and the cholesteric liquid crystal layer 113, and a first luminous flux is obtained accordingly. Please refer to FIG. 1C and FIG. 2D, when the user wants to erase (delete or clear) partial or all of the writing track S, the light L can be used to irradiate the to-be-erased portion of the writing track S (e.g., the irradiation region P of FIG. 1C and FIG. 2D). The irradiation region P may be equal to or larger than the portion to be erased. In this embodiment, the irradiation region P (the dashed rectangle as shown in FIG. 1C) is larger than the to-be-erased portion (the lower part of “◯” filled with white color as shown in FIG. 1C) as an example for explanation. The intensity of the light L is preferably greater than the intensity of the ambient light, and the wavelength of the light L may be located in the range of a visible light (e.g., red, blue or green light) or in the range of an invisible light (e.g., near-infrared light, far-infrared light or ultraviolet light). When the light L irradiates the light-entering surface A1 of the cholesteric liquid crystal device 11 (as the irradiation region P in FIG. 1C and FIG. 2D), it also passes through the first substrate 111 and the cholesteric liquid crystal layer 113 and travels to the photo-sensing array layer 12. At this time, the photo-sensing element 1211′ in the corresponding photo-sensing area 121 under the irradiation region P of the light L can sense the luminous flux of the light L emitted thereon, and a second luminous flux is obtained accordingly. Moreover, the difference between the first luminous flux and the second luminous flux is the luminous flux change sensed by the photo-sensing element 1211′ in the photo-sensing dot-area 121. In this embodiment, the second luminous flux sensed by the photo-sensing element 1211′ is greater than the first luminous flux. Hence, the luminous flux change sensed by the one or more of the photo-sensing elements 1211′ in the photo-sensing dot-areas 121 is positive. However, the luminous flux change sensed by the photo-sensing element 1211 not irradiated by the light L is 0 (i.e., the second luminous flux sensed thereby is equal to the first luminous flux). Accordingly, the sensing-signal processing circuitry 13 coupled to the read-lines Rm and Rm+1 can receive (or “read”), via the read-lines Rm and Rm+1, electrical signals (i.e., “sensing signal Ss”) corresponding to different voltage values generated by each of the photo-sensing elements 1211 and 1211′ that senses the light fluxes with different intensities. When the sensing-signal processing circuitry 13 receives this sensing signal(s) Ss, it is obtained that which one, or which ones, of the photo-sensing elements 1211′ transmit the sensing signal Ss. The sensing-signal processing circuitry 13 can output the position data Cs according to this sensing signal Ss to the voltage control circuitry 14, and the position data Cs represents or corresponds to the position where said one or ones of the photo-sensing element 1211′ (in FIG. 2D, two photo-sensing elements 1211′ are taken as an example) which sense(s) this luminous flux change locate(s) in the photo-sensing array layer 12 sensing this luminous flux change in the photo-sensing array layer 12 (e.g., at which column and row said photo-sensing element(s) 1211 locate(s) in the photo-sensing array layer 12). Hence, the voltage control circuitry 14 may obtain the position data Cs regarding to where said one, or ones, of the light sensing element 1211′ having such luminous flux change locates in the photo-sensing array layer 12. The position data Cs corresponds to or represents the position of the photo-sensing element 1211′ regarding to where it locates in the irradiation region P of the light L which is irradiated on the light-entering surface A1 of the cholesteric liquid crystal device 11. After the voltage control circuitry 14 receives the position data Cs generated by the sensing-signal processing circuitry 13 due to the luminous flux change, the outputted voltage signal Ds is applied to the first electrode 1141 and the second electrode 1151′ of the liquid crystal control area 118′ (in FIG. 2D, two liquid crystal control areas 118′ are taken as an example) corresponding to the irradiation region P, so that the orientation of cholesteric liquid crystal molecules between the first electrode 1141 and the second electrode 1151′ can be changed to the focal conic state from the original planar state, so as to allow a light to substantially penetrate through the cholesteric liquid crystal layer 113 and to render the background color of the cholesteric liquid crystal device 11. Hence, the portions of the writing track S shown on the cholesteric liquid crystal writing board 1 irradiated by the light L can be erased, either partially or entirely.

In addition, the sensing signals Ss read by the read-lines Rm and Rm+1 may be transmitted to the voltage control circuitry 14 when the upload-lines UPn turn on. Alternatively, the sensing signals Ss read by the read-lines Rm and Rm+1 may also be transmitted to the voltage control circuitry 14 in a blanking time after the upload-lines UPn turn on. In other words, the read sensing signal Ss will be transmitted to the voltage control circuitry 14 in the meantime while the upload-lines UPn sequentially turn on. Alternatively, all sensing signals Ss may be transmitted once (non-immediately) in the blanking time after all upload-lines UPn have turned on and before the next time that they are turned on, and the present invention is not limited thereto.

In other embodiments (explanations are made according to FIG. 2D), the first transparent electroconductive layer 114 may be a whole electrode, and is comprehensively disposed on the surface of the first substrate 111 facing toward the cholesteric liquid crystal layer 113. The second transparent electroconductive layer 115 may comprise electrode blocks (still labeled as 1151) arranged in an array, the electrode blocks 1151 are respectively disposed in correspondence with the photo-sensing dot-areas 121 or the photo-sensing elements 1211 arranged in an array. The electrode blocks 1151 and the first transparent electroconductive layer 114 may correspondingly form the liquid crystal control areas. Herein, “comprehensively” means that the first transparent electroconductive layer 114 comprises a whole common electrode, which fully covers most of the surface of the first substrate 111 facing toward the cholesteric liquid crystal layer 113. One electrode block 1151 of the second transparent electroconductive layer 115 may correspond to a pixel electrode and correspondingly form a liquid crystal control area together with the first transparent electroconductive layer 114. Hence, the voltage signal Ds may be applied to the first transparent electroconductive layer 114 and the electrode blocks 1151 (i.e., pixel electrode) in the liquid crystal control area(s) 118 corresponding to the writing track S, so that the orientation of the cholesteric liquid crystal molecules in the corresponding liquid crystal control area(s) 118 can be changed to the focal conic state from the original planar state, so as to partially or entirely erase the portion(s) of the writing track S on the cholesteric liquid crystal writing board 1 irradiated by the light L.

Alternatively, in other embodiments, as shown in FIG. 3D, which is a schematic view showing another embodiment of a second transparent electroconductive layer of the cholesteric liquid crystal writing board of this disclosure. The first transparent electroconductive layer 114 or the second transparent electroconductive layer 115 may comprise a plurality of electrode blocks 1151. The electrode blocks 1151 are disposed in correspondence with the liquid crystal control areas 118, and the voltage signal Ds may be applied to the electrode blocks 1151 of the liquid crystal control area 118 corresponding to the writing track S, so that the orientation of the cholesteric liquid crystal molecules in the corresponding liquid crystal control area(s) 118 can be changed to the focal conic state from the original planar state so as to partially or entirely erase the writing track S on the cholesteric liquid crystal writing board 1 irradiated by the light L. In this embodiment, for example, the second transparent electroconductive layer 115 comprises a plurality of electrode blocks 1151 arranged in an array. The electrode blocks 1151 are respectively disposed in correspondence with the photo-sensing dot-areas 121 or the photo-sensing elements 1211 arranged in an array, and the electrode blocks 1151 and the first transparent electroconductive layer 114 may correspondingly form more than one liquid crystal control areas. Herein, the electrode block 1151 may be polygonal (e.g., square), circular, or oval, or in other shapes. Alternatively, in other embodiments, the first transparent electroconductive layer 114 may also comprise a plurality of electrode blocks 1141, and the second transparent electroconductive layer 115 comprises a whole common electrode. Further alternatively, as shown in FIG. 3E, each of the first transparent electroconductive layer 114 and the second transparent electroconductive layer 115 independently comprises a plurality of electrode blocks 1141 and 1151 disposed in correspondence with each other, and each electrode block 1141 forms the liquid crystal control area 118 with its corresponding electrode block 1151. In FIG. 3E, for example, the electrode blocks 1141 and 1151 are correspondingly arranged as “seven-segmented blocks.” A photo-sensing area 121 is corresponding provided in each of the liquid crystal control areas 118. As previously mentioned, the amount, configuration, location, and shape of the electrode blocks may be adjusted according to the practicing requirements, and the present invention is not limited thereto.

Referring again to FIG. 2D, the cholesteric liquid crystal device 11 of this embodiment further comprises an insulating layer 117, and the second transparent electroconductive layer 115, the insulating layer 117 and the photo-sensing array layer 12 are sequentially stacked on a surface of the second substrate 112 facing toward the cholesteric liquid crystal layer 113.

In addition, as shown in FIG. 2A and FIG. 2D, the cholesteric liquid crystal writing board 1 of this embodiment may further comprise a backing plate B disposed on one side of the second substrate 112 facing toward the light-emitting surface A2. Herein, the backing plate B may be a black light-absorbing plate or a white light-reflecting plate. When the backing plate B is the black light-absorbing plate, it absorbs the light that passes through the cholesteric liquid crystal device 11 and makes the cholesteric liquid crystal writing board 1 become a blackboard. In some embodiments, the material(s) of the black light-absorbing plate may be the same as the material(s) used to make the black matrix of the liquid crystal display device. In addition, when the backing plate B is a white light-reflecting plate, it reflects the light that passes through the cholesteric liquid crystal device 11 and makes the cholesteric liquid crystal writing board 1 become a whiteboard. In some embodiments, the material of the white light reflective plate may comprise, for example, metal, metal oxide, a highly reflective paint (white paint) or a combination thereof, and the present invention is not limited thereto. Alternatively, in other embodiments, the color of the reflective plate is also not limited to white, and may be one of other colors or a combination of multiple colors.

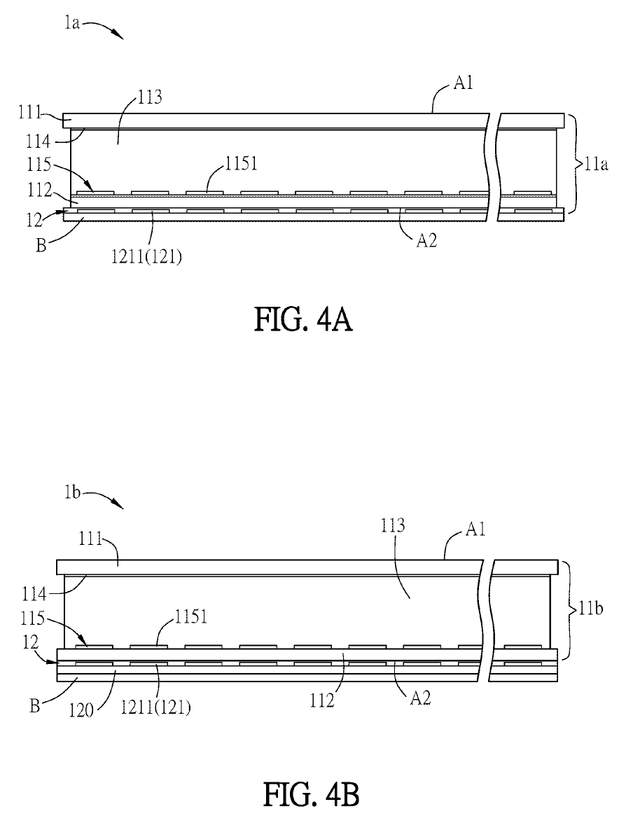

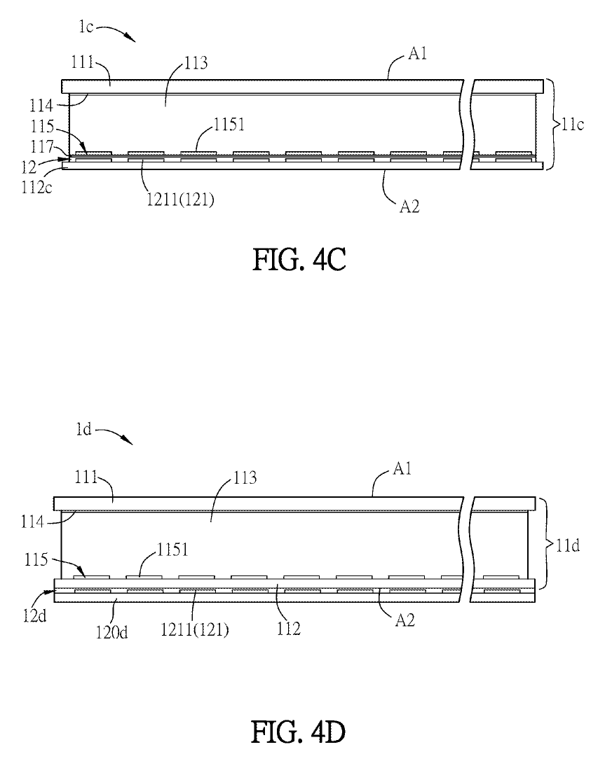

Please refer to FIG. 4A to FIG. 4D, which are schematic structure views showing various embodiments of the cholesteric liquid crystal writing board of this disclosure, respectively. In FIG. 4A to FIG. 4D, the sensing-signal processing circuitry 13 and the voltage control circuitry 14 are omitted.

As shown in FIG. 4A, the cholesteric liquid crystal writing board 1a of this embodiment and the cholesteric liquid crystal writing board 1 of the foregoing embodiment are also substantially the same in the composition and the connection relationship of the components. The difference is that the insulating layer 117 is not provided in a cholesteric liquid crystal writing board 1a of this embodiment. The second transparent electroconductive layer 115 is disposed on the surface of the second substrate 112 facing toward the cholesteric crystal layer 113. The photo-sensing array layer 12 is disposed on the surface of the second substrate 112 opposite to (or away from) the cholesteric crystal layer 113, and between the backing plate B and the second substrate 112.

As shown in FIG. 4B, the cholesteric liquid crystal writing board 1b of this embodiment and the cholesteric liquid crystal writing board 1 of the foregoing embodiment are also substantially the same in the composition and the connection relationship of the components. The difference is that, in the cholesteric liquid crystal writing board 1b of this embodiment, the photo-sensing array layer 12 further comprises a third substrate 120, and the photo-sensing elements 1211 arranged in an array are disposed on a surface of the third substrate 120 facing toward the second substrate 112. The photo-sensing array layer 12 is disposed on one side of the second substrate 112 opposite to (or away from) the cholesteric liquid crystal layer 113. In other words, the photo-sensing array layer 12 is disposed outside of the cholesteric liquid crystal device 11, and is located on the side of the light-emitting surface A2 of the cholesteric liquid crystal device 11. In this embodiment, the applicable material for the third substrate 120 may be the same as those can used in the first substrate 111 and the second substrate 112 of the cholesteric liquid crystal writing board 1 in the foregoing embodiment, and may be a flexible transparent material or a rigid transparent material.

As shown in FIG. 4C, the cholesteric liquid crystal writing board 1c of this embodiment and the cholesteric liquid crystal writing board 1 of the foregoing embodiment are also substantially the same in the composition and the connection relationship of the components. The difference is that the backing plate B is not provided in a cholesteric liquid crystal writing board 1c of this embodiment. The first substrate 111 is still a transparent substrate, but the second substrate 112c is a black light-absorbing substrate or a white light-reflecting substrate. In this embodiment, the second substrate 112c also has both functions of the second substrate 112 and the backing plate B in the foregoing embodiment.

As shown in FIG. 4D, the cholesteric liquid crystal writing board 1d of this embodiment and the cholesteric liquid crystal writing board 1 of the foregoing embodiment are also substantially the same in the composition and the connection relationship of the components. The difference is that the backing plate B is also not provided in a cholesteric liquid crystal writing board 1d of this embodiment. A photo-sensing array layer 12d further comprises a third substrate 120d, the photo-sensing elements 1211 arranged in an array are disposed on a surface of the third substrate 120d facing toward the second substrate 112, and the photo-sensing array layer 12d is disposed on one side of the second substrate 112 opposite to (or away from) the cholesteric liquid crystal layer 113. In other words, the photo-sensing array layer 12d is disposed outside the cholesteric liquid crystal device 11, and is located on one side of the cholesteric liquid crystal device 11 facing toward the light-emitting surface A2. Meanwhile, the first substrate 111 and the second substrate 112 are still transparent substrates, but the third substrate 120d is a black light-absorbing plate or a white light-reflecting plate, or a plate of other colors. In other words, in this embodiment, the third substrate 120d also has both functions of the third substrate 120 and the backing plate B in the foregoing embodiment. Because the photo-sensing array layer 12d is disposed outside of the cholesteric liquid crystal device 11, no insulating layer is necessary to be provided on the second substrate 112.

In summary, in the cholesteric liquid crystal writing board according to the present disclosure, the cholesteric liquid crystal device comprises a plurality of liquid crystal control areas. The photo-sensing layer which comprises a plurality of photo-sensing dot-areas arranged in an array is disposed on one side of the light-emitting surface of the cholesteric liquid crystal device. A photo-sensing element of the photo-sensing dot-area(s) may sense a luminous flux change and generate a sensing signal accordingly. Said photo-sensing dot-area(s) corresponds to at least one of the liquid crystal control areas. The sensing-signal processing circuitry receives the sensing signal and accordingly outputs position data of the photo-sensing element in the photo-sensing array layer. The voltage control circuitry receives the position data and accordingly outputs a voltage signal to the liquid crystal control area corresponding to the position data, so that cholesteric liquid crystal molecules corresponding to partial or all portions of the liquid crystal control areas are morphologically changed so as to erase partial or all portions of the writing track accordingly. Hence, the cholesteric liquid crystal writing board of the present disclosure utilizes the properties of the cholesteric liquid crystal. In addition to achieving power-saving, it is also possible to perform a function of erasing the designated portion(s) of an image displayed on the cholesteric liquid crystal writing board, so as to expand the application of the cholesteric liquid crystal writing board on the teaching or conference.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A cholesteric liquid crystal writing board capable of displaying a writing track and comprising:
a cholesteric liquid crystal device, which comprises a cholesteric liquid crystal layer, has a light-entering surface and a light-emitting surface opposite to the light-entering surface, and comprises a plurality of liquid crystal control areas;
a photo-sensing array layer disposed on one side of the light-emitting surface of the cholesteric liquid crystal device, wherein the photo-sensing array layer comprises a plurality of photo-sensing dot-areas arranged in an array, and a photo-sensing element of one of the photo-sensing dot-areas senses a luminous flux change and generates a sensing signal accordingly, wherein said one of the photo-sensing dot-areas corresponds to at least one of the liquid crystal control areas;
a sensing-signal processing circuitry coupled to the photo-sensing array layer, wherein the sensing-signal processing circuitry receives the sensing signal and accordingly outputs position data of the photo-sensing element in the photo-sensing array layer; and
a voltage control circuitry coupled to the sensing-signal processing circuitry and the cholesteric liquid crystal device, wherein the voltage control circuitry receives the position data and accordingly outputs a voltage signal to the liquid crystal control area corresponding to the position data, so that cholesteric liquid crystals corresponding to partial or all portions of the liquid crystal control areas are morphologically changed so as to erase partial or all portions of the writing track accordingly.

2. The cholesteric liquid crystal writing board according to claim 1, wherein the cholesteric liquid crystal device further comprises a first substrate and a second substrate opposite to the first substrate, the cholesteric liquid crystal layer is disposed between the first substrate and the second substrate, the cholesteric liquid crystal device further comprises a first transparent electroconductive layer disposed on a surface of the first substrate facing toward the cholesteric liquid crystal layer, and the cholesteric liquid crystal device further comprises a second transparent electroconductive layer disposed on one side of the second substrate facing toward the cholesteric liquid crystal layer.

3. The cholesteric liquid crystal writing board according to claim 2, wherein the first transparent electroconductive layer comprises a plurality of first electrodes which extend in a first direction and are separately disposed, the second transparent electroconductive layer comprises a plurality of second electrodes which extend in a second direction and are separately disposed, and the first direction is different from the second direction.

4. The cholesteric liquid crystal writing board according to claim 3, wherein when viewing from a top of the light-entering surface, the first electrodes are crossed with the second electrodes to correspond to the liquid crystal control areas.

5. The cholesteric liquid crystal writing board according to claim 4, wherein the voltage signal is applied to the first electrode and the second electrode of one or more of the liquid crystal control areas corresponding to the position data, so that the cholesteric liquid crystals corresponding to partial or all of said one or more of the liquid crystal control areas are morphologically changed.

6. The cholesteric liquid crystal writing board according to claim 2, wherein the second transparent electroconductive layer comprises a plurality of electrode blocks arranged in an array, the electrode blocks are disposed in correspondence with the photo-sensing dot-areas, and the electrode blocks and the first transparent electroconductive layer correspondingly form the liquid crystal control areas.

7. The cholesteric liquid crystal writing board according to claim 6, wherein the voltage signal is applied to the electrode blocks of one or more of the liquid crystal control areas corresponding to the writing track, so that the cholesteric liquid crystals corresponding to partial or all of said one or more of the liquid crystal control areas are morphologically changed.

8. The cholesteric liquid crystal writing board according to claim 2, wherein the first transparent electroconductive layer or the second transparent electroconductive layer comprises a plurality of electrode blocks, and the electrode blocks are disposed in correspondence with the liquid crystal control areas.

9. The cholesteric liquid crystal writing board according to claim 8, wherein the voltage signal is applied to the electrode blocks of one or more of the liquid crystal control areas corresponding to the position data, so that the cholesteric liquid crystals corresponding to partial or all of said one or more of the liquid crystal control areas are morphologically changed.

10. The cholesteric liquid crystal writing board according to claim 2, wherein the cholesteric liquid crystal device further comprises an insulating layer, and the second transparent electroconductive layer, the insulating layer and the photo-sensing array layer are sequentially stacked on a surface of the second substrate facing toward the cholesteric liquid crystal layer.

11. The cholesteric liquid crystal writing board according to claim 2, wherein the photo-sensing array layer is disposed on a surface of the second substrate opposite to the cholesteric liquid crystal layer in a back-to-back manner.

12. The cholesteric liquid crystal writing board according to claim 2, wherein the photo-sensing array layer is disposed on one side of the second substrate opposite to the cholesteric liquid crystal layer, the photo-sensing array layer further comprises a third substrate, and the photo-sensing dot-areas arranged in the array are disposed on a surface of the third substrate facing toward the second substrate.

13. The cholesteric liquid crystal writing board according to claim 1, wherein the photo-sensing array layer further comprises:
a plurality of upload-lines and a plurality of read-lines which are disposed crossed to the upload-lines to define the photo-sensing dot-areas, wherein a switch element and one of the photo-sensing elements are disposed in each of the photo-sensing dot-areas, a control terminal of the switch element is connected to one of the upload-lines, a first terminal of the switch element is connected to one of the read-lines, a second terminal of the switch element is connected to one terminal of said photo-sensing element, and the other terminal of said photo-sensing element is connected to a reference voltage.

14. The cholesteric liquid crystal writing board according to claim 13, wherein the sensing signal is transmitted to the sensing-signal processing circuitry when the upload-lines are turned on.

15. The cholesteric liquid crystal writing board according to claim 13, wherein the sensing signal is transmitted to the sensing-signal processing circuitry in a blanking time after the upload-lines are turned on.

16. The cholesteric liquid crystal writing board according to claim 1, wherein a light irradiates the light-entering surface of the cholesteric liquid crystal device to generate the luminous flux change, and the position data comprises position information regarding to where the cholesteric liquid crystal device is irradiated by the light.

17. The cholesteric liquid crystal writing board according to claim 16, wherein the light is a visible light or an invisible light.
